(19) United States
(12) Patent Application Publication
(10) Pub. No.: US 2026/0338370 A1
(43) Pub. Date: Oct. 29, 2026

(54) MODULAR DECORATIVE GLASS FOR SCENTED CANDLE

(71) Applicant: Jian Zhou, Nanchong (CN)

(72) Inventor: Jian Zhou, Nanchong (CN)

(21) Appl. No.: 19/189,358

(22) Filed: Apr. 25, 2025

(51) Int. Cl. F21V 35/00

(52) U.S. Cl. CPC F21V 35/00

(57) ABSTRACT

Disclosed is a modular decorative glass for a scented candle, including a glass bowl, where a surface of the glass bowl is provided with a spherical container, an upper end of the spherical container is provided with an insertion opening, and a flange diameter of the glass bowl is the same as a diameter of the insertion opening; the spherical container is configured to accommodate a decorative item, the spherical container is a configured as a transparent glass bottle, and a bottom of the spherical container is flat, the glass bowl is configured to hold the scented candle. When in use, the scented candle is placed inside the glass bowl, a preserved flower is placed inside the spherical container, the glass bowl is then placed inside the spherical container, and the scented candle is finally lit, therefore, a user can directly see the preserved flower.

### TECHNICAL FIELD

The present disclosure relates to the technical field of decorative glass, and particularly to a modular decorative glass for a scented candle.

### BACKGROUND

Decorative glass for scented candles is used to hold scented candles, usually in the form of a glass cup. When in use, a scented candle is placed inside the glass cup, and then lit to light up a room.

The inventor has found in daily work that although decorative glass can enhance ornamental effect by engraving patterns on the glass cup, it is still not simple and beautiful enough to impress a user at first sight.

### SUMMARY

In order to solve the problem mentioned in the prior art, the present disclosure provides a modular decorative glass for a scented candle.

In order to achieve the above objectives, the present disclosure adopts the following technical solutions: a modular decorative glass for a scented candle, including a glass bowl, where a surface of the glass bowl is provided with a spherical container.

The effect achieved by the above components is as follows: when in use, the scented candle is placed inside the glass bowl, a preserved flower is placed inside the spherical container, the glass bowl is then placed inside the spherical container, and the scented candle is finally lit; and the spherical container is a configured as transparent glass bottle, a user can directly see the preserved flower, thereby improving the ornamental effect of the scented candle when being used in the decorative glass as much as possible.

In some embodiments, an upper end of the spherical container is provided with an insertion opening, and a flange diameter of the glass bowl is the same as a diameter of the insertion opening.

The effect achieved by the above components is as follows: by arranging the insertion opening, the glass bowl can be placed into the insertion opening and is snugly seated on the insertion opening, and the glass bowl is configured to hold the scented candle. Since the glass bowl is transparent, it does not affect the ornamental effect of the product, and can be used to hold the scented candle, ensuring that the scented candle will not fall off, and the burning of the scented candle will not damage the product, such that integrity and aesthetics of the product are ensured, and it is convenient for cleaning the scented candle after use. In addition, the preserved flower is placed inside a semi-enclosed space of the spherical container, which can prevent the preserved flower from being easily affected by moisture, and extend the service life of the preserved flower.

In some embodiments, the spherical container is configured to accommodate a decorative item, and the spherical container is shaped as a spherical glass bottle.

The effect achieved by the above components is as follows: since the glass bowl holding the scented candle is placed inside the spherical container, and the spherical container is configured to hold the preserved flower (the preserved flower is made of a 100% real flower and fresh flower through 36 processes, which retains the original appearance of the fresh flower and has a lifespan of 3-5 years), such that the ornamental effect of the preserved flower is perfectly combined with the aromatherapy function of the scented candle.

In some embodiments, a bottom of the spherical container is flat.

The effect achieved by the above components is as follows: by setting a bottom of the spherical container to be flat, the product may be placed stably on a tabletop.

In some embodiments, the glass bowl is configured to hold the scented candle.

The effect achieved by the above components is as follows: since the glass bowl is configured to hold the scented candle and the glass bowl is transparent, the transparent glass bowl does not affect the ornamental effect of the product.

In some embodiments, the spherical container is configured as a transparent glass bottle.

The effect achieved by the above components is as follows: since the spherical container is a transparent glass bottle, the user can directly see the preserved flower inside the glass bottle, thereby improving the ornamental effect of the preserved flower.

In summary, the present invention has the following beneficial effects:

In the present disclosure, when in use, the scented candle is placed inside the glass bowl, a preserved flower is placed inside the spherical container, the glass bowl is then placed inside the spherical container, and the scented candle is finally lit; and the spherical container is a transparent glass bottle, a user can directly see the preserved flower, thereby improving the ornamental effect of the scented candle when being used in the decorative glass as much as possible. Therefore, the present disclosure solves the problem in the prior art that although decorative glass can enhance ornamental effect by engraving patterns on the glass cup, it is still not simple and beautiful enough to impress a user at first sight.

### BRIEF DESCRIPTION OF THE DRAWINGS

FIG. 1 is a schematic diagram of a three-dimensional structure of the present disclosure.

FIG. 2 is an exploded view of a three-dimensional structure of the present disclosure.

FIG. 3 is a sectional view of a three-dimensional structure of the present disclosure.

Reference numerals in the accompanying drawings: 1. spherical container; 2. glass bowl; and 3. insertion opening.

### DETAILED DESCRIPTIONS OF THE EMBODIMENTS

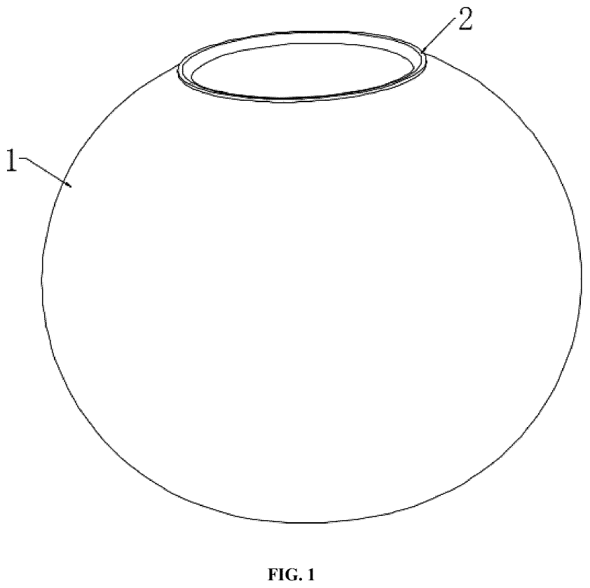

With reference to FIG. 1, the present disclosure provides a technical solution: a modular decorative glass for a scented candle, including a glass bowl 2, where a surface of the glass bowl 2 is provided with a spherical container 1; when in use, the scented candle is placed inside the glass bowl 2, a preserved flower is placed inside the spherical container 1, the glass bowl 2 is then placed inside the spherical container 1, and the scented candle is finally lit; and the spherical container 1 is a transparent glass bottle, a user can directly see the preserved flower, thereby improving the ornamental effect of the scented candle when being used in the decorative glass as much as possible.

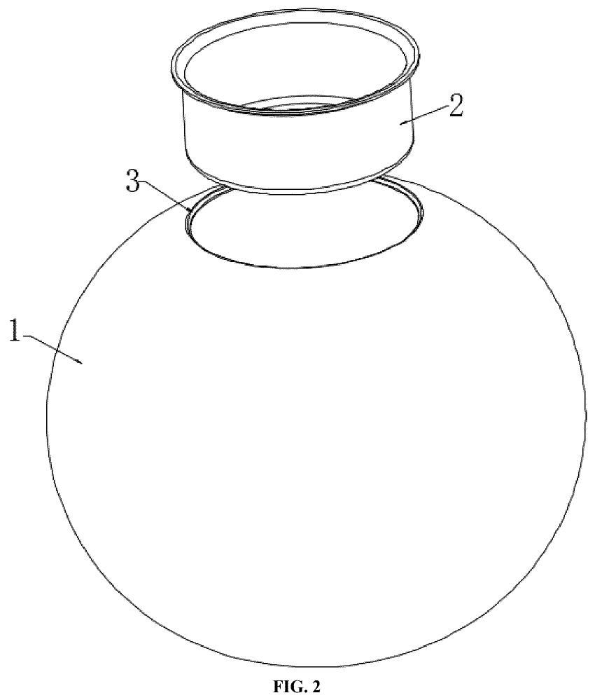

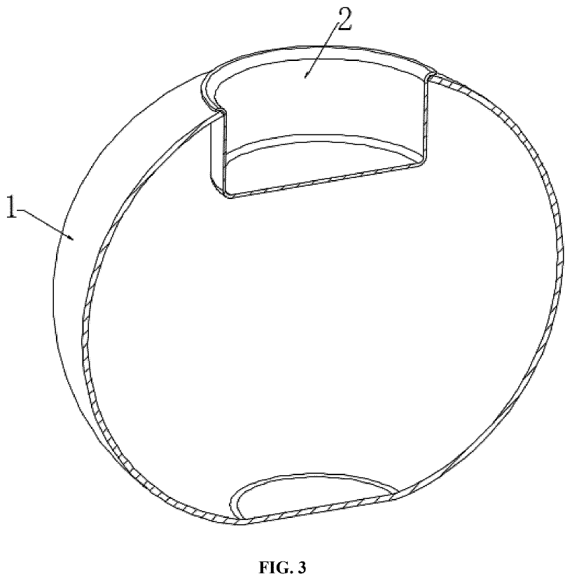

With reference to FIGS. 2 and 3, in this embodiment, an upper end of the spherical container 1 is provided with an insertion opening 3, and a flange diameter of the glass bowl 2 is the same as a diameter of the insertion opening 3; by arranging the insertion opening 3, the glass bowl 2 can be placed into the insertion opening 3 and is snugly seated on the insertion opening 3, and the glass bowl 2 is configured to hold the scented candle. Since the glass bowl 2 is transparent, it does not affect the ornamental effect of the product, and can be used to hold the scented candle, ensuring that the scented candle will not fall off, and the burning of the scented candle will not damage the product, such that integrity and aesthetics of the product are ensured, and it is convenient for cleaning the scented candle after use. In addition, the preserved flower is placed inside a semi-enclosed space of the spherical container 1, which can prevent the preserved flower from being easily affected by moisture, and extend the service life of the preserved flower. The spherical container 1 is configured to accommodate a decorative item and is shaped as a spherical glass bottle. Since the glass bowl 2 holding the scented candle is placed inside the spherical container 1, and the spherical container 1 is configured to hold the preserved flower (the preserved flower is made of a 100% real flower and fresh flower through 36 processes, which retains the original appearance of the fresh flower and has a lifespan of 3-5 years), such that the ornamental effect of the preserved flower is perfectly combined with the aromatherapy function of the scented candle, and a bottom of the spherical container 1 is flat, allowing it to be placed stably on a tabletop.

With reference to FIG. 3, in this embodiment, the glass bowl 2 is configured to hold the scented candle. Since the glass bowl 2 is transparent, it does not affect the ornamental effect of the product. The spherical container 1 is a transparent glass bottle, such that a user can directly see the preserved flower inside the glass bottle, thereby improving the ornamental effect of the preserved flower.

Working principle:

To use the product, the user places the scented candle into the glass bowl 2, places the preserved flower into the spherical container 1, then places the glass bowl 2 into the spherical container 1, and finally lights the scented candle. As the spherical container 1 is a transparent glass bottle, a user can directly see the preserved flower, thereby improving the ornamental effect of the scented candle when being used in the decorative glass as much as possible. By arranging the insertion opening 3, the glass bowl 2 can be placed into the insertion opening 3 and is snugly seated on the insertion opening 3, and the glass bowl 2 is configured to hold the scented candle. Since the glass bowl 2 is transparent, it does not affect the ornamental effect of the product, and can be used to hold the scented candle, ensuring that the scented candle will not fall off, and the burning of the scented candle will not damage the product, such that integrity and aesthetics of the product are ensured, and it is convenient for cleaning the scented candle after use. In addition, the preserved flower is placed inside a semi-enclosed space of the spherical container 1, which can prevent the preserved flower from being easily affected by moisture, and extend the service life of the preserved flower. Since the glass bowl 2 holding the scented candle is placed inside the spherical container 1, and the spherical container 1 is configured to hold the preserved flower (the preserved flower is made of a 100% real flower and fresh flower through 36 processes, which retains the original appearance of the fresh flower and has a lifespan of 3-5 years), such that the ornamental effect of the preserved flower is perfectly combined with the aromatherapy function of the scented candle, and a bottom of the spherical container 1 is flat, allowing it to be placed stably on a tabletop. The glass bowl 2 is configured to hold the scented candle, the transparent glass bowl 2 does not affect the ornamental effect of the product, and the spherical container 1 is a transparent glass bottle, such that the user can directly see the preserved flower inside the glass bottle, thereby improving the ornamental effect of the preserved flower.

The above description is merely preferred embodiments of the present disclosure, and is not intended to limit the present disclosure in any form. Those skilled in the art may use the above technical contents to modify or change the same into equivalent embodiments with equivalent changes and apply them to other fields. However, any simple alteration, equivalent change and improvement which are made to the above embodiments in accordance with the technical essence of the present disclosure without departing from the contents of the technical solutions of the present disclosure shall fall within the scope of protection scope of the technical solution of the present disclosure. In the description of the present disclosure, it should be noted that, unless otherwise explicitly specified and defined, the terms “mounting”, “connecting” and “connection” should be understood in a broad sense, for example, they may be a fixed connection, a detachable connection, or an integrated connection; may be a mechanical connection, or an electrical connection; and may be a direct connection, or an indirect connection via an intermediate medium, or communication inside two elements. For those of ordinarily skilled in the art, specific meanings of the above terms in the present disclosure could be understood according to specific circumstances.

What is claimed is:

1. A modular decorative glass for a scented candle, comprising a glass bowl, wherein a surface of the glass bowl is provided with a spherical container.

2. The modular decorative glass for a scented candle according to claim 1, wherein an upper end of the spherical container is provided with an insertion opening, and a flange diameter of the glass bowl is the same as a diameter of the insertion opening

3. The modular decorative glass for a scented candle according to claim 2, wherein the spherical container is configured to accommodate a decorative item, and the spherical container is a spherical glass bottle.

4. The modular decorative glass for a scented candle according to claim 3, wherein a bottom of the spherical container is flat.

5. The modular decorative glass for a scented candle according to claim 4, wherein the glass bowl is configured to hold the scented candle.

6. The modular decorative glass for a scented candle according to claim 5, wherein the spherical container is configured as a transparent glass bottle.
